(19) United States
(12) Patent Application Publication
(10) Pub. No.: US 2024/0033843 A1
(43) Pub. Date: Feb. 1, 2024

(54) SYSTEMS AND METHODS FOR MONITORING AND CONTROLLING WELDING MACHINE CONNECTIONS

(71) Applicant: Novarc Technologies Inc., North Vancouver (CA)

(72) Inventors: Daniel HARVEY, North Vancouver (CA); Mathieu BOULLET, Montreuil (FR); Ahmad ASHOORI, Vancouver (CA); Trevor DUNNETT, North Vancouver (CA)

(21) Appl. No.: 18/255,489

(22) PCT Filed: Jan. 7, 2022
(86) PCT No.: PCT/CA2022/050025

§ 371 Date: Jun. 1, 2023

Related U.S. Application Data
(60) Provisional application No. 63/199,558, filed on Jan. 8, 2021.

(51) Int. Cl. B23K 9/10

(52) U.S. Cl. CPC B23K 9/10

(57) ABSTRACT

The present disclosure provides systems and methods for controlling a welding machine comprising an electrode lead and a workpiece lead connectible to one of a plurality of welding platforms. An example method comprises determining if the workpiece lead is connected to a desired welding platform mounting a workpiece to be welded, and only applying a welding current to the electrode lead when the workpiece lead is connected to the desired welding platform. Determining if the workpiece lead is connected to the desired welding platform may comprise applying a probing current to the electrode lead and contacting the electrode lead to a workpiece mounted on one of the plurality of welding platforms, and monitoring current through ground connections of the welding platforms and determining that the workpiece lead is connected to the desired welding platform if less than a threshold current level is detected flowing through any ground connection.

### CROSS-REFERENCE TO RELATED APPLICATION

This patent application claims priority to U.S. provisional patent application No. 63/199,558 filed Jan. 8, 2021, the entire content of which is incorporated by reference herein.

### TECHNICAL FIELD

The present disclosure relates to welding machines. Particular embodiments relate to systems and methods for monitoring and controlling electrical connections between welding machines and workpieces.

### BACKGROUND

Proper electrical connections are important for welding operations. Improper connections can be dangerous to operators, and can result in damage to equipment, in particular when the welding machine is part of a robotic welding system.

The inventors have determined a need for improved systems and methods for monitoring and controlling welding machine connections.

### SUMMARY

One aspect provides a method for controlling a welding machine comprising an electrode lead and a workpiece lead connectible to one of a plurality of welding platforms. The method comprises determining if the workpiece lead is connected to a desired welding platform mounting a workpiece to be welded, and only applying a welding current to the electrode lead when the workpiece lead is connected to the desired welding platform. Determining if the workpiece lead is connected to the desired welding platform may comprise applying a probing current to the electrode lead and contacting the electrode lead to a workpiece mounted on one of the plurality of welding platforms, and monitoring current through a ground connection of each welding platform and determining that the workpiece lead is connected to the desired welding platform if less than a threshold current level is detected flowing through the ground connection of any welding platform.

Another aspect provides a welding system comprising a welding machine having an electrode lead and a workpiece lead, a plurality of welding platforms, each welding platform having a workpiece mounted thereon, and a platform sensing circuit configured to determine if the workpiece lead is connected to a desired welding platform mounting a workpiece to be welded.

Another aspect provides a welding system comprising a welding machine having an electrode lead and a workpiece lead, a plurality of welding platforms, each welding platform having a workpiece mounted thereon, and an automatic platform switching assembly comprising a plurality of switches, each switch selectively connecting one of the plurality of welding platforms to the workpiece lead, and a controller controlling the plurality of switches.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 schematically illustrates electrical connections of an example welding system according to one embodiment of the present disclosure.

FIG. 1A shows the welding system of FIG. 1 with an improper connection.

FIG. 2 is a flowchart illustrating steps of a method according to one embodiment of the present disclosure.

FIG. 2A is a flowchart illustrating steps of a method according to another embodiment of the present disclosure.

FIG. 2B is a flowchart illustrating steps of a method according to another embodiment of the present disclosure.

FIG. 3 shows a robotic welding system that includes a platform sensing circuit and an automatic platform switching assembly according to one embodiment of the present disclosure.

FIG. 4 shows the auxiliary cabinet housing the automatic platform switching assembly of FIG. 3 with the door open to illustrate example positioning of components of the automatic platform switching assembly according to one embodiment of the present disclosure.

FIG. 5 shows the main control cabinet of the robotic welding system of FIG. 3 with a door removed to illustrate example positioning of components of the platform sensing circuit according to one embodiment of the present disclosure.

FIG. 6 shows an example wiring schematic for an automatic platform switching assembly according to one embodiment of the present disclosure.

### DETAILED DESCRIPTION

The following describes example welding systems that are configured for use with a plurality of welding platforms. The term “welding platform” is used herein to refer to any structure configured to hold and or move a workpiece to be welded. In some embodiments, the welding systems comprise robotic welding systems of the types described in PCT patent application publication no. WO 2019/153090 and PCT patent application publication no. WO 2017/165964, which are hereby incorporated by reference herein, and the welding platforms comprise positioners configured to rotate pipe sections. Such collaborative robotic welding systems are commercially available from Novarc Technologies Inc., and may be referred to in certain examples as a “Spool Welding Robot” or “SWR”™. However, it is to be understood that an automatic platform switching assembly and/or a platform sensing circuit according to the present disclosure could be included in other types of welding systems, whether robotic or manually operated or any combination thereof.

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein. It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

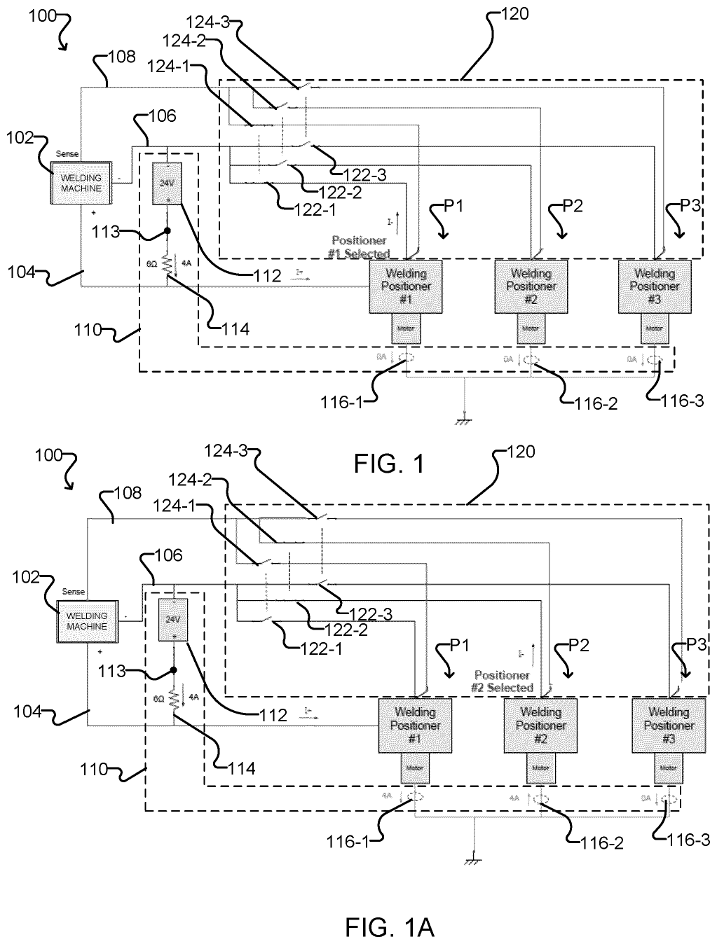

FIG. 1 schematically illustrates electrical connections of an example welding system 100 according to one embodiment of the present disclosure. The welding system 100 comprises a welding machine 102 having an electrode lead 104, a workpiece lead 106, and a voltage sense lead 108. In a welding operation, the workpiece lead 106 and voltage sense lead 108 are connected to a workpiece to welded (typically through a welding platform on which the workpiece is mounted), and a welding current (typically around 100 A or more) is applied to the electrode lead 104, which is moved relative to the workpiece to perform the desired weld. The welding system 100 also comprises a platform sensing circuit 110, and an automatic platform switching assembly 120 as described further below. In the illustrated example, the welding system 100 is configured for use with three welding platforms, namely positioners P1, P2 and P3, but it is to be understood that the system could accommodate any number of welding platforms.

The platform sensing circuit 110 comprises a current source connected between the electrode lead 104 and the workpiece lead 106 configured to apply a probing current to the electrode lead 104, and a plurality of current sensors 116 connected to monitor current flowing through ground connections of the welding platforms. Each current sensor 116-1, 116-2 and 116-3 is connected to measure the current through the ground connection of a respective one of the positioners P1, P2, P3, and provide a signal indicative of such ground connection current to a controller (not shown) that controls the overall operation of the welding system 100. In some embodiments, the controller comprises a programmable logic controller (PLC) programmed using ladder logic.

In the illustrated example, the current source comprises a voltage source 112 and a power resistor 114 and is configured to apply a DC probing current of 4 amps. However, it is to be understood that the current source could deliver a different probing current and/or take different forms in other embodiments, depending on the configuration of the welding system 100. In some embodiments, the probing current is a DC current of less than 10 amps. In some embodiments, the probing current is a DC current of less than 5 amps. In some embodiments, an AC current may be used as the probing current. In some embodiments, the platform sensing circuit 110 could be configured to generate one or more pulses of current, a repeating pattern of pulses, or some other signal along the electrode lead 104 that is detectable by sensors connected to the welding platforms.

In the illustrated example, a voltage monitor 113 is connected to monitor the voltage across the power resistor for confirming that the probing current is being applied to the electrode lead 104, to avoid a “false negative” that could occur if the current is not properly applied. For example, if the electrode lead 104 does not contact the workpiece (e.g. due to an improperly calibrated robotic system performing a “poke test” as described below), or if the electrode lead 104 contacts paint or another non-conductive material on the workpiece, the probing current will not be detected by the current sensors 116 even if the workpiece lead 106 is improperly connected. In other embodiments, the platform sensing circuit 110 may comprise different means for confirming that the probing current is being properly applied to the workpiece through the electrode lead 104.

In operation, prior to performing a welding operation, the controller activates the voltage source 112 to apply the probing current to the electrode lead 104, and the electrode lead 104 is placed contact with the workpiece to be welded. In some embodiments, the controller also confirms that the probing current is properly applied (for example by measuring the voltage across resistor 114 with monitor 113, or by other suitable means). If the workpiece lead 106 and voltage sense lead 108 are properly connected to the platform holding the workpiece to be welded, as shown for example in FIG. 1, no currents flow through the ground connections of the welding platforms and the controller proceeds with the welding operation and causes the welding machine 102 to apply a welding current to the electrode lead; otherwise the controller either alerts the operator of a connection problem, or automatically corrects the connection problem, as discussed further below.

In embodiments where the welding system 100 comprises a robotic welding system, the controller may be configured to conduct an automated “poke test” prior to starting a welding operation by briefly contacting the workpiece and applying the probing current. In some embodiments the welding system may proceed with welding or provide feedback (e.g. a connection alert) or correction (e.g. by means of an automatic platform switching assembly) within about 1-2 seconds or less, such that an operator may not even be aware that the poke test occurred.

In the examples illustrated in FIGS. 1 and 1A, the welding system 100 comprises an automatic platform switching assembly 120 with automated switches for connecting the workpiece lead 106 and the voltage sense lead 108. However, such a switching assembly is not required in all embodiments. For example, in some embodiments the workpiece lead 106 and the voltage sense lead 108 are manually connected (e.g. by clips, plugs, or other suitable mechanisms) to the workpiece/platform by an operator of the welding system, and the welding system 100 is configured to perform a poke test and provide the operator with an alert if there are any connection problems detected. The alert may identify which workpieces/platform(s) should be connected and disconnected in some embodiments. Similarly, in some embodiments the automatic platform switching assembly 120 may be implemented in welding systems that do not include a platform sensing circuit.

FIG. 1A shows an example of the welding system of FIG. 1 with an improper connection, in that positioner P2 is connected to the workpiece lead 106 and voltage sense lead 108 of the welding machine 102, but the workpiece to be welded is mounted on positioner P1. When the electrode lead 104 makes electrical contact with the workpiece on positioner P1, the probing current (4 amps in the illustrated example) flows towards ground through the ground connection of positioner P1 and is detected by current sensor 116-1, and flows away from ground through the ground connection of positioner P2 and is detected by current sensor 116-2. In the FIG. 1A example, the system 100 includes an automatic platform switching assembly 120 comprising a plurality of platform switches 122-1, 122-2, 122-3 selectively connecting the positioners P1, P2, P3 to the workpiece lead 106, and a plurality of sensing switches 124-1, 124-2, 124-3 selectively connecting the positioners P1, P2, P3 to the voltage sense lead. Accordingly, the controller can automatically fix the connection problem by opening switches 122-2 and 124-2 and closing switches 122-1 and 124-1 (thus returning to the configuration shown in FIG. 1). In other embodiments without an automatic platform switching assembly, the controller can generate an alert as discussed below.

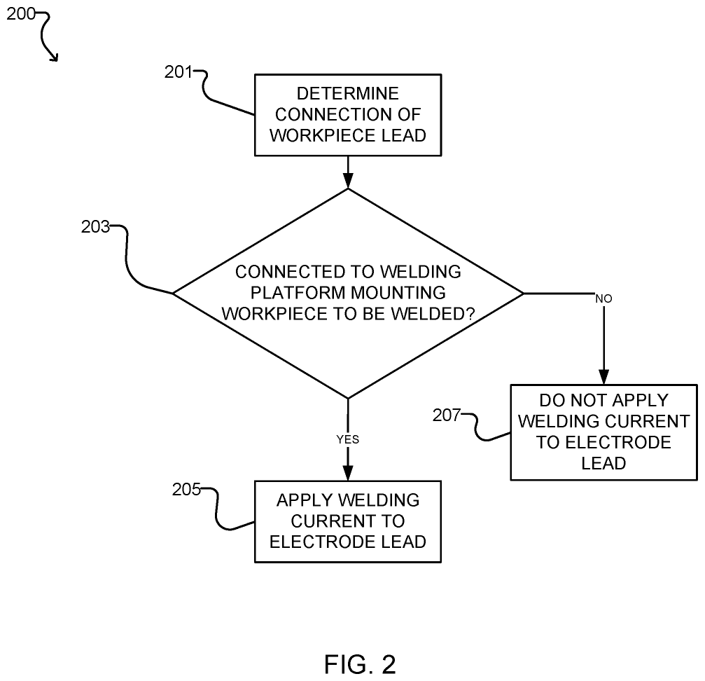

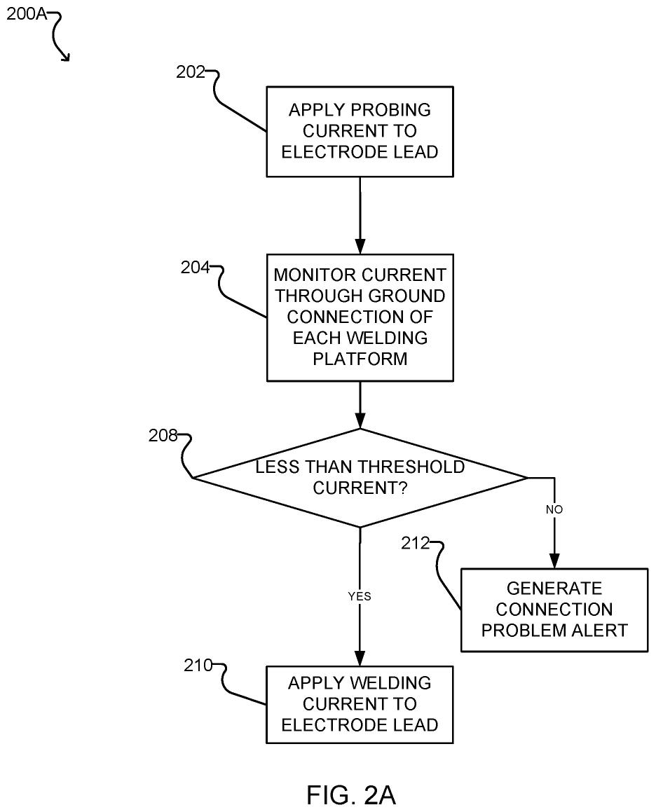

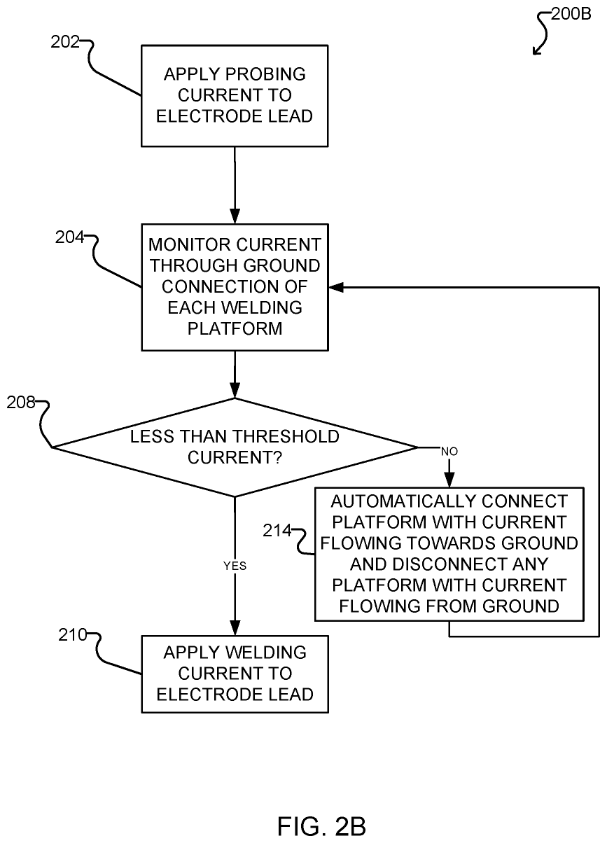

FIG. 2 is a flowchart illustrating steps of an example method 200 for controlling a welding system that includes a welding machine comprising an electrode lead and a workpiece lead connectible to one of a plurality of welding platforms according to one embodiment of the present disclosure. The method 200 may, for example be executed by a welding system controller connected to control operation of the welding machine to execute a welding operation. Prior to initiating the welding operation, which involves applying a welding current to the electrode lead, the controller executes method 200 to confirm that the workpiece lead is correctly connected to a desired welding platform mounting the workpiece to be welded. At step 201, the controller determines the connection(s) of the workpiece lead. At step 203, the controller determines if the workpiece lead is connected to a desired welding platform mounting the workpiece to be welded. In some embodiments, determining if the workpiece lead is connected to the desired welding platform comprises applying a probing current to the electrode lead, which is contacted to the workpiece, as discussed below. In other embodiments, determining if the workpiece lead is connected to the desired welding platform may comprise other techniques that do not require contacting the workpiece, such as for example ultrasonic-based connection detection, laser-based or other optical-based connection detection, or other suitable means. If the workpiece lead is connected to the desired welding platform (step 203 YES output), the controller proceeds to step 205 and applies a welding current to begin performing a welding operation. If the workpiece lead is not connected to the desired welding platform (step 203 NO output), the controller proceeds to step 207 and does not apply a welding current or initiates a welding operation. Depending on the configuration of the welding system, at step 207 the controller may also generate an alert, or automatically correct the connection problem, as discussed further below.

FIG. 2A is a flowchart illustrating steps of an example method 200A for controlling a welding system according to another embodiment of the present disclosure. At step 202, the controller applies a probing current to the electrode lead. In some embodiments, at step 202 the controller also confirms that the probing current is properly applied, for example by measuring the voltage across resistor 114 with monitor 113, or by other suitable means, as described above. At step 204, the controller monitors the currents through the ground connections of the welding platforms. In some embodiment, the currents through the ground connections of the welding platforms are monitored prior to applying the probing current and during application of the probing current, and only the difference is counted as detected current so as to cancel out any ambient noise that may exist in the system. If there is less than a threshold level of current detected through all of the ground connections (step 208 YES output), the controller initiates a welding operation and applies a welding current to the electrode lead at step 210. The threshold level of current may be selected based on the characteristics of the welding system and the probing current. In some embodiments the threshold level of current is 0.5 amps. In some embodiments the threshold level of current is selected based on the probing current, such as for example 20% of the probing current. In some embodiments a lower threshold may be used. If there is more than the threshold level of current detected through any of the ground connections (step 208 NO output), the controller generates a connection problem alert. The connection problem alert may indicate which welding platform(s) should be connected/disconnected in some embodiments.

FIG. 2B is a flowchart illustrating steps of an example method 200B for sensing and automatically correcting platform connection problems in a welding system according to another embodiment of the present disclosure. Method 200B is the same as method 200A except that if there is more than the threshold level current detected (step 208 NO output), the controller automatically connects the workpiece lead to the platform with current flowing towards ground through its ground connection, and disconnects the workpiece lead from any platform(s) with current flowing away from ground through its ground connection at step 214.

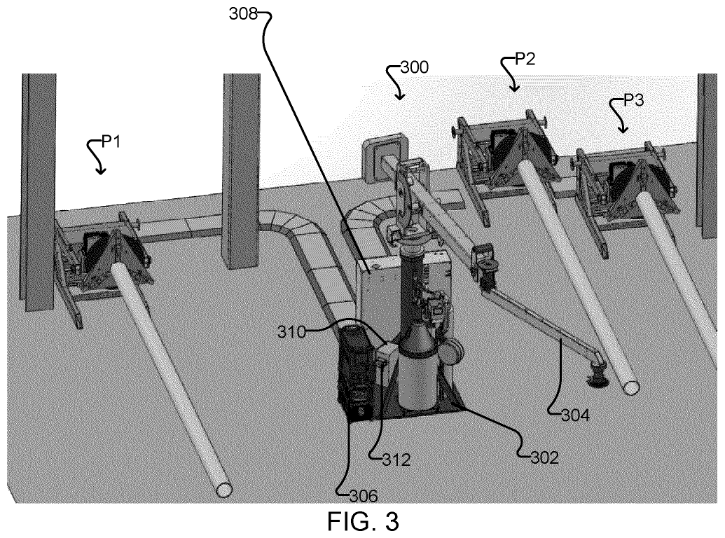

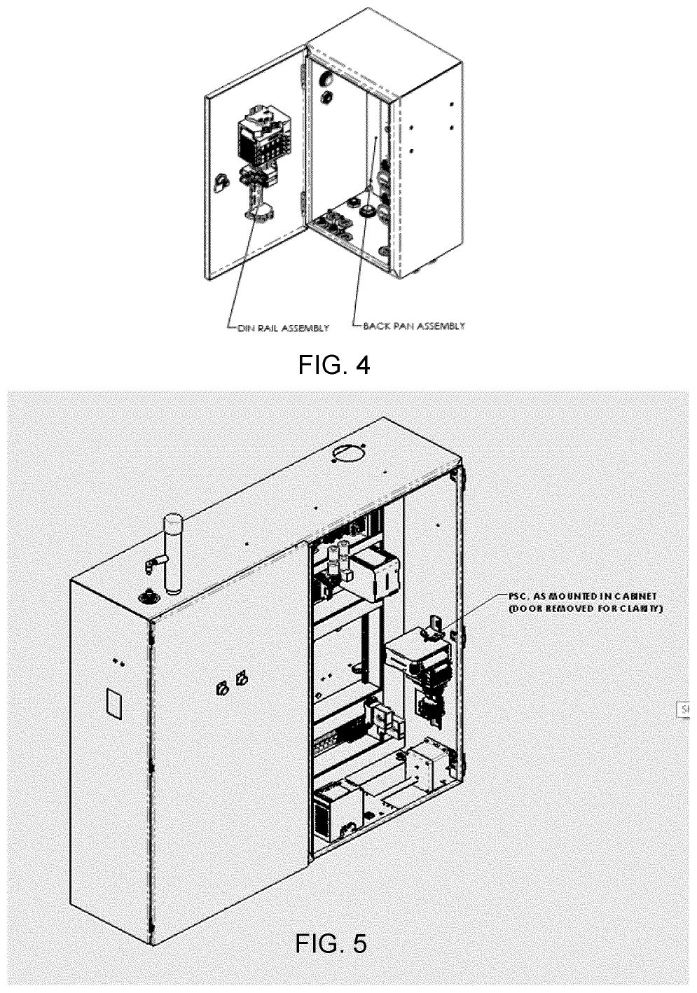

FIG. 3 shows a robotic welding system 300 having an automatic platform switching assembly and a platform sensing circuit according to one embodiment of the present disclosure. The robotic welding system 300 comprises a base 302 which has a repositionable support structure 304 and a welding machine 306 mounted thereon. A robotic manipulator (not shown) is supported from the end of the arm of the support structure 304, and comprises a welding torch connected to the welding machine 306 is controlled by a controller (e.g. a PLC) installed within a main control cabinet 308 to execute a welding operation. The repositionable support structure 304 can be used to move the robotic manipulator to a plurality of locations throughout a workspace, which in the illustrated example includes three positioners P1, P2, P3 with workpieces (pipe sections) mounted thereon. An automatic platform switching assembly is installed within an auxiliary cabinet 310 (shown with the door open in FIG. 4 to illustrate example positioning of components) and operably coupled to the positioners P1, P2, P3. In the illustrated example, the platform sensing circuit is installed within the main control cabinet 308 which is shown with one door removed in FIG. 5 to illustrate example positioning of components. The connections between the platform sensing circuit and the electrode lead, workpiece lead, and voltage sense lead, are made within a relay box 312 mounted on the exterior of the auxiliary cabinet 310 to isolate the welding power source from the main control cabinet 308.

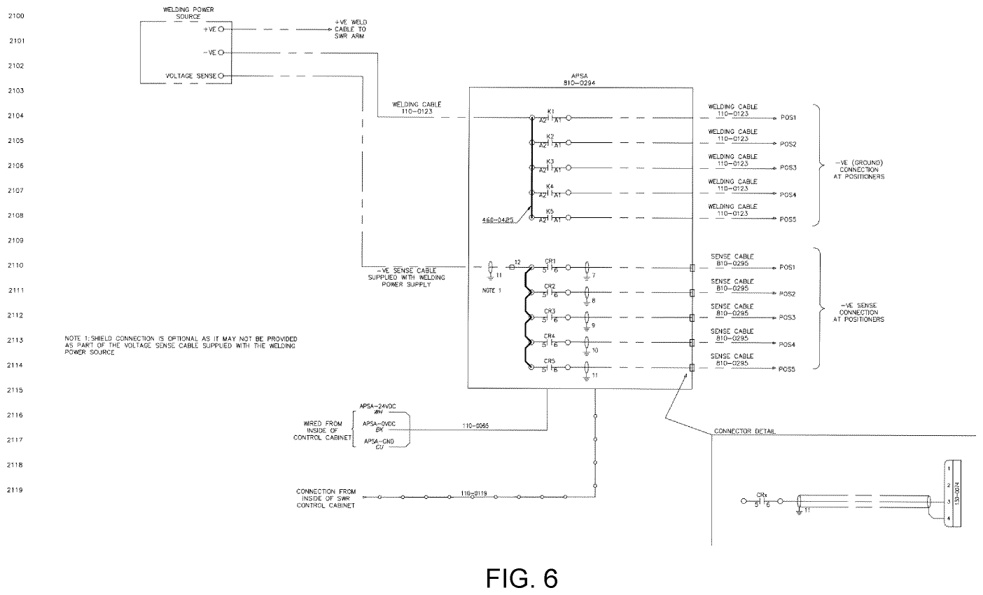

FIG. 6 shows an example wiring schematic for an automatic platform switching assembly according to one embodiment of the present disclosure. The example shown in FIG. 6 is configured for connection to a Spool Welding Robot of the types described in PCT patent application publication no. WO 2019/153090 and PCT patent application publication no. WO 2017/165964 and commercially available from Novarc Technologies Inc., and can accommodate five welding platforms (positioners in the illustrated example), but it is to be understood that the circuitry shown therein could be adapted for use with different types of welding systems and to accommodate different numbers of welding platforms. As one skilled in the art will appreciate, a high current contactor switch can potentially get stuck, and as such in some embodiments each of the switches in the automatic platform switching assembly for connecting the workpiece lead to the welding platforms also comprises an auxiliary contactor coupled to the controller to ensure that all of the switches are in the correct state, or generate an alarm if all of the switches are not in the correct state.

The embodiments of the systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface. For example, the programmable computers may be a server, network appliance, connected or autonomous vehicle, set-top box, embedded device, computer expansion module, personal computer, laptop, personal data assistant, cloud computing system or mobile device. A cloud computing system is operable to deliver computing service through shared resources, software and data over a network. Program code is applied to input data to perform the functions described herein and to generate output information. The output information is applied to one or more output devices to generate a discernible effect. In some embodiments, the communication interface may be a network communication interface. In embodiments in which elements are combined, the communication interface may be a software communication interface, such as those for inter-process communication. In still other embodiments, there may be a combination of communication interfaces.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Embodiments described herein may relate to various types of computing applications, such as image processing and generation applications, computing resource related applications, speech recognition applications, video processing applications, semiconductor fabrication, and so on. By way of illustrative example embodiments may be described herein in relation to image-related applications.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments of the present disclosure may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As will be apparent to those skilled in the art in light of the foregoing disclosure, many alterations and modifications are possible to the methods and systems described herein. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as may reasonably be inferred by one skilled in the art. The scope of the claims should not be limited by the embodiments set forth in the examples, but should be given the broadest interpretation consistent with the foregoing disclosure.

The present disclosure may be embodied in other specific forms without departing from its spirit or essential characteristics. The described embodiments are to be considered in all respects only as illustrative and not restrictive.

1. A method for controlling a welding machine comprising an electrode lead and a workpiece lead connectible to one of a plurality of welding platforms, the method comprising determining if the workpiece lead is connected to a desired welding platform mounting a workpiece to be welded, and only applying a welding current to the electrode lead when the workpiece lead is connected to the desired welding platform.

2. The method of claim 1, wherein determining if the workpiece lead is connected to the desired welding platform comprises:
a. applying a probing current to the electrode lead and contacting the electrode lead to a workpiece mounted on one of the plurality of welding platforms; and
b. monitoring current through a ground connection of each welding platform and determining that the workpiece lead is connected to the desired welding platform if less than a threshold current level is detected flowing through the ground connection of any welding platform.

3. The method of claim 2 comprising, if less than the threshold current level is detected flowing through the ground connection of any welding platform, ending contact between the electrode lead and the workpiece and applying the welding current to the electrode lead.

4. The method of claim 2 comprising, if more than the threshold current level is detected flowing through the ground connection of any of the plurality of welding platforms, automatically connecting the workpiece lead to a selected one of the plurality of welding platforms with current flowing towards ground though the ground connection and disconnecting the workpiece lead from the other welding platforms.

5. The method of claim 2 comprising, if more than the threshold current level is detected flowing through the ground connection of any of the plurality of welding platforms, generating a connection problem alert.

6. The method of claim 5 wherein the connection problem alert identifies the desired welding platform of the plurality of welding platforms as the one with current flowing towards ground though the ground connection to be connected to the workpiece lead.

7. The method of claim 2 wherein the probing current is under 10 amps.

8. The method of claim 2 wherein the threshold current level is 0.5 amps.

9. The method of claim 2 wherein the threshold current level is 20% of the probing current.

10. The method of claim 1 wherein the welding machine is part of a robotic welding system.

11. A welding system comprising:
a. a welding machine having a electrode lead and a workpiece lead;
b. a plurality of welding platforms, each welding platform having a workpiece mounted thereon; and,
c. a platform sensing circuit configured to determine if the workpiece lead is connected to a desired welding platform mounting a workpiece to be welded.

12. The welding system of claim 11 wherein the platform sensing circuit comprises a probing current source connected between the electrode lead and the workpiece lead, and a plurality of current sensors, each current sensor connected to measure current through a ground connection of one of the plurality of welding platforms.

13. The welding system of claim 12 wherein the probing current source comprises a voltage source and a power resistor.

14. The welding system of claim 13 wherein the probing current source comprises a voltage monitor connected to monitor the voltage across the power resistor for confirming that the probing current is being applied to the electrode lead.

15. The welding system of claim 2 wherein the probing current source is configured to generate a probing current of under 10 amps.

16. The welding system of claim 11 comprising an automatic platform switching assembly comprising a plurality of switches, each switch selectively connecting one of the plurality of welding platforms to the workpiece lead, and a controller controlling the plurality of switches.

17. A welding system comprising:
a. a welding machine having a electrode lead and a workpiece lead;
b. a plurality of welding platforms, each welding platform having a workpiece mounted thereon; and,
c. an automatic platform switching assembly comprising a plurality of switches, each switch selectively connecting one of the plurality of welding platforms to the workpiece lead, and a controller controlling the plurality of switches.
